(19) United States
(12) Patent Application Publication
(10) Pub. No.: US 2022/0263781 A1
(43) Pub. Date: Aug. 18, 2022

(54) METHOD AND SYSTEM FOR MANAGING AVATAR USAGE RIGHTS

(71) Applicant: LINE Plus Corporation, Seongnam-si (KR)

(72) Inventor: Yunji LEE, Seongnam-si (KR)

(73) Assignee: LINE Plus Corporation, Seongnam-si (KR)

(21) Appl. No.: 17/672,916

(22) Filed: Feb. 16, 2022

(30) Foreign Application Priority Data
Feb. 16, 2021 (KR) 10-2021-0020731

(51) Int. Cl. H04L 51/10; H04L 51/00

(52) U.S. Cl. CPC H04L 51/10; H04L 51/12

(57) ABSTRACT

A method for managing avatar usage rights including transmitting a request to use an avatar of a second user who is registered as a messenger friend of a first user of a user terminal on an instant messaging service, and in response to the request to use the avatar of the second user being accepted by the second user, allowing the use of the avatar of the second user in the user terminal associated with the first user may be provided.

### CROSS-REFERENCE TO RELATED APPLICATION

This application claims priority to Korean Patent Application No. 10-2021-0020731, filed in the Korean Intellectual Property Office on Feb. 16, 2021, the entire contents of which are hereby incorporated by reference.

### BACKGROUND

### Field

The present disclosure relates to methods and/or systems for managing avatar usage rights, and more particularly, to methods and/or systems for managing avatar usage rights for using an avatar of another user in an instant messaging application.

### Description of Related Art

With the proliferation of mobile devices such as smartphones or the like and the development of the Internet, instant messaging services using mobile devices are widely used. These instant messaging services provide avatar services as a means of expressing a user. The ‘avatar’ as used herein may refer to a virtual graphic used as an alter ego of a user online. That is, the avatar has a similar characteristic to the personal information of the user of the instant messaging service.

In general, the user of the instant messaging service may use his or her avatar to use various avatar services. Meanwhile, because the avatar has the similar characteristic to the personal information of the user, various problems may occur when the user is allowed to freely use the avatar of another user without prior consent.

### SUMMARY

In order to solve the problems described above, the present disclosure provides methods for, a non-transitory computer-readable recording medium storing instructions for, and/or systems (apparatuses) for managing avatar usage rights.

The present disclosure may be implemented in a variety of ways, including methods, systems (apparatuses), or a non-transitory computer-readable recording medium storing instructions.

According to an example embodiment, a method for managing avatar usage rights performed by a user terminal including at least one processor includes transmitting a request to use an avatar of a second user who is registered as a messenger friend of a first user of the user terminal on an instant messaging service, and in response to the request to use the avatar of the second user being accepted by the second user, allowing the use of the avatar of the second user in the user terminal associated with the first user.

According to an example embodiment, the method may further include receiving data about the avatar of the second user, and generating an image including the avatar of the second user based on an input of the first user.

According to an example embodiment, the method may further include receiving data about the avatar of the second user, and creating an image including the avatar of the first user and the avatar of the second user based on an input of the first user.

According to an example embodiment, the method may further include displaying a third image in a chat room, in which the first user and the second user are included. The third image may include the avatar of the second user and at least one of a visual object or a message for an anniversary associated with the first user.

According to an example embodiment, before the request to use the avatar of the second user is accepted by the second user, the use of the avatar of the second user registered as the messenger friend of the first user may not be allowed.

According to an example embodiment, even when the request to use the avatar of the second user is accepted by the second user, the use of the avatar of the first user in another user terminal associated with the second user may not be allowed.

According to an example embodiment, even when a messenger friend relationship between the first user and the second user is terminated, the use of the avatar of the second user in the user terminal may be maintained as allowed.

According to an example embodiment, the method may further include, in response to the request to use the avatar of the second user being accepted by the second user, displaying a fourth image including the avatar of the second user instead of a profile image associated with the second user.

According to an example embodiment, the method may further include, in response to the request to use the avatar of the second user being accepted by the second user, displaying an icon, which indicates that use of the avatar of the second user is allowed, on a profile of the second user.

According to an example embodiment, the method may further include receiving a request to use the avatar of the first user from another user terminal associated with the second user, receiving an input of the first user accepting the request to use the avatar of the first user, and in response to receiving the input of the first user, transmitting an acceptance message allowing the use of the avatar of the first user in the another user terminal.

According to an example embodiment, the method further includes, before transmitting the acceptance message, disallowing the use of the avatar of the first user in the another user terminal.

According to an example embodiment, the method may further include receiving an input of the first user allowing other users to use the avatar of the first user, and in response to receiving the input of the fist user, allowing the use of the avatar of the first user in another user terminal associated with the second user, from among the other users.

There is provided a non-transitory computer-readable recording medium storing instructions that, when executed by at least one processor, causes a user terminal to perform the method described above.

According to an example embodiment, a user terminal is provided, which may include a memory configured to store one or more computer-readable programs, and one or more processors connected to the memory and configured to execute the one or more computer-readable programs included in the memory such that the one or more processors cause the user terminal to transmit a request to use an avatar of a second user who is registered as a messenger friend of a first user on an instant messaging service, and in response to the request to use the avatar of the second user being accepted by the second user, allow the use of the avatar of the second user in the user terminal associated with the first user.

According to an example embodiment, an information processing system includes a memory configured to store one or more computer-readable programs, and one or more processors connected to the memory and configured to execute the one or more computer-readable programs included in the memory such that the one or more processors are configured to cause the information processing system to receive a request to use an avatar of a second user from a first user terminal associated with a first user through an instant messaging application, the first user and the second user being users registered as messenger friends on the instant messaging service, transmit the request to use the avatar of the second user to a second user terminal associated with the second user through the instant messaging application, receive an acceptance message allowing the use of the avatar of the second user in the first user terminal from the second user terminal through the instant messaging application, and in response to receiving the acceptance message from the second user terminal, register the second user as an avatar friend of the first user.

According to an example embodiment, the one or more processor may be further configured to cause the information processing system to transmit data about the avatar of the second user to the first user terminal through the instant messaging application in response to registering the second user as an avatar friend of the first user.

According to an example embodiment, the one or more processors may be further configured to cause the information processing system to transmit an image to the first user terminal through a chat room, in which the first user and the second user are included, wherein the image includes the avatar of the second user and at least one of a visual object or a message about an anniversary associated with the first user.

According to an example embodiment, the one or more processors are further configured to cause the information processing system to disallow the use of the avatar of the second user before the second user is registered as the avatar friend of the first user.

According to an example embodiment, the one or more processors are further configured to cause the information processing system to disallow the use of the avatar of the first user in the second user terminal even when the second user is registered as the avatar friend of the first user.

According to an example embodiment, the one or more processors may be further configured to cause the information processing system to receive a request to use an avatar of the first user from the second user terminal through the instant messaging application, transmit the request to use the avatar of the first user to the first user terminal through the instant messaging application, receive an acceptance message allowing the use of the avatar of the first user in the second user terminal from the first user terminal through the instant messaging application, in response to receiving the acceptance message from the first user terminal, register the first user as an avatar friend of the second user, and in response to registering the first user as the avatar friend of the second user, transmit data about the avatar of the first user to the second user terminal through the instant messaging application.

In various example embodiments of the present disclosure, users of the instant messaging service may block or prevent his or her avatars from being used indiscriminately by other users who are not allowed.

In various example embodiments of the present disclosure, the user may create an image, a video, a sticker, an emoticon, and the like by using not only his or her avatar but also the avatar of another user registered as his or her avatar friend.

The effects of the present disclosure are not limited to the effects described above, and other effects not described herein can be clearly understood by those of ordinary skill in the art (referred to as “ordinary technician”) from the description of the claims.

### BRIEF DESCRIPTION OF THE DRAWINGS

The above and other objects, features and advantages of the present disclosure will become more apparent to those of ordinary skill in the art by describing in detail some example embodiments thereof with reference to the accompanying drawings, in which:

FIG. 1 is a diagram illustrating an example in which an avatar system is provided through an instant messaging application operating in a user terminal according to an example embodiment;

FIG. 2 is a schematic diagram illustrating a configuration in which an information processing system is communicatively connected to a plurality of user terminals in order to provide a service for managing avatar usage rights according to an example embodiment;

FIG. 3 is a block diagram illustrating an internal configuration of the user terminal and the information processing system according to an example embodiment;

FIG. 4 is a flowchart illustrating a method for performing a registration of an avatar friend between a first user terminal, an information processing system, and a second user terminal according to an example embodiment;

FIG. 5 is a diagram illustrating an example in which a user transmits an avatar friend request according to an example embodiment;

FIG. 6 is a diagram illustrating an example in which a second user accepts an avatar friend request of a first user according to an example embodiment;

FIG. 7 is a diagram illustrating an example in which a user sets avatar usage rights according to an example embodiment;

FIG. 8 is a diagram illustrating an example of creating an image including avatars of the other users according to an example embodiment;

FIG. 9 is a diagram illustrating an example of hiding or blocking an avatar friend according to an example embodiment;

FIG. 10 is a diagram illustrating an example in which an image for an anniversary is displayed according to an example embodiment; and

FIG. 11 is a flowchart illustrating a method for managing avatar usage rights according to an example embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. Further, in the following description of the example embodiments, duplicate descriptions of the same or corresponding components may be omitted. However, even if descriptions of components are omitted, it is not intended that such components are not included in any example embodiment.

Advantages and features of the disclosed example embodiments and methods of accomplishing the same will be apparent by referring to the example embodiments described below in connection with the accompanying drawings. However, the present disclosure is not limited to the example embodiments disclosed below, and may be implemented in various different forms, and the present example embodiments are merely provided to make the present disclosure complete, and to fully disclose the scope of the inventive concepts to those skilled in the art to which the present disclosure pertains.

The terms used herein will be briefly described prior to describing the disclosed example embodiments in detail. The terms used herein have been selected as general terms which are widely used at present in consideration of the functions of the present disclosure, and this may be altered according to the intent of an operator skilled in the art, conventional practice, or introduction of new technology. Further, in specific cases, certain terms may be arbitrarily selected by the applicant, and the meaning of the terms will be described in detail in a corresponding description of the example embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to reproduce one or more processors. Accordingly, as an example, the “module” or “unit” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an embodiment, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination of processing devices, e.g., a combination of a DSP and a microprocessor, a plurality of microprocessors, one or more microprocessors in conjunction with a DSP core, or any other combination of such configurations. Further, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, a “chat room” may refer to a virtual space or group in which one or more users (or user accounts) may participate, which may be generated in an instant messaging application and the like installed on a computing device. For example, one or more users may participate or be included in the chat room and exchange various types of messages, files, and the like. Further, in the chat room, Voice over Internet Protocol (VoIP) voice call function, a VoIP video call function, a live broadcasting function (VoIP real-time video transmission function), and a graphic object (e.g., emoji, Animoji, and the like) function are provided, enabling voice calls, video calls, video streaming, graphic object transmission, and the like between users.

In the present disclosure, a “user” may refer to a user or a user account using an instant messaging service application, an avatar providing service application, or the like. The “user account” as used herein may represent an account used by the user in an instant messaging service application, an avatar provision service application or the like, or data related thereto.

In the present disclosure, “messenger friends” are those in such a relationship that can exchange instant messages on the instant messaging application with each other, and the user can register a counterpart as a messenger friend by a phone number, an ID, and the like of the counterpart without requiring an acceptance from the counterpart. Further, “avatar friends” may refer to those in such a relationship that can use avatars of the counterparts on instant messaging service application, avatar provision service application, and the like, and this relationship may be determined or formed when there is an acceptance of the counterpart (e.g., counterpart who is the messenger friend). The avatar friend is a relationship different from the messenger friend, and user A, who is in a messenger friend relationship with user B, still needs to obtain permission from user B and register user B as his or her avatar friend in order to use the avatar of the user B. Further, when user A registers user B as his or her avatar friend with the permission of user B, this does not mean that user B is immediately allowed to use the avatar of the user A too, and accordingly, user B is also required to additionally obtain the permission of user A and register user A as his or her avatar friend to use the avatar of user A.

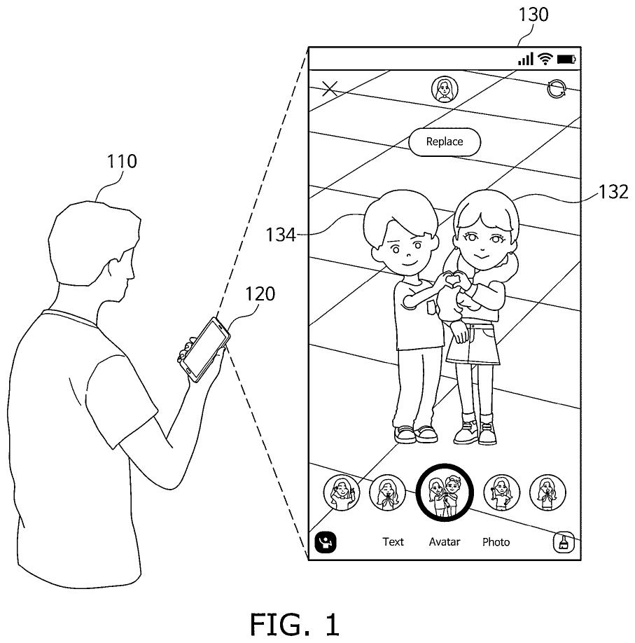

FIG. 1 is a diagram illustrating an example in which an avatar service is provided through an instant messaging application operating in a user terminal 120 according to an example embodiment. A user 110 may use the user terminal 120 to exchange messages with another user subscribing to the instant messaging application or to use an avatar service. In this case, the avatar service may include a video call service using an avatar, an image (e.g., image, video, emoticon, or sticker) creation service, a profile editing service, and a story (e.g., SNS post) editing service, and the like.

In an example embodiment, the user 110 may use his or her avatar 134 and/or an avatar 132 of another user on the instant messaging application. As illustrated, the user 110 may capture an image/video (e.g., AR image/video) including his or her avatar 134 and the avatar 132 of another user through a user interface 130, but is not limited thereto. For example, the user 110 may create emoticon, sticker, profile image, profile decoration, and the like including his or her avatar 134 and/or the avatar 132 of another user and utilize it for various purposes, such as editing a profile, use in chat room, creating a story, and the like.

In an example embodiment, the user 110 may use the avatar 132 of another user after obtaining permission from the another user to use the avatar 132 of the another user. For example, the user 110 may transmit a request to use the avatar 132 to the another user who is registered as a messenger friend on the instant messaging service. Accordingly, when the another user accepts the request to use the avatar 132, the user 110 may use the avatar 132 of the another user in various services. In other words, (even when the another user is the messenger friend of the user 110) the user 110 cannot use the avatar 132 of the another user until the request to use the avatar 132 is accepted by the another user.

In an example embodiment, even when the user 110 is able to use the avatar 132 of the another user (as the another user is a registered avatar friend of the user 110), the another user may not be allowed to use the avatar 134 of the user 110. In other words, even the another user who accepted the request to use the avatar 132 of the another user also needs to transmit the user 110 a request to use the avatar 134 of the user 110, and is allowed to use the avatar 134 of the user 110 after the request is accepted by the user 110. With such a configuration, users of the instant messaging service may block or prevent his or her avatars from being used indiscriminately by other users who are not allowed.

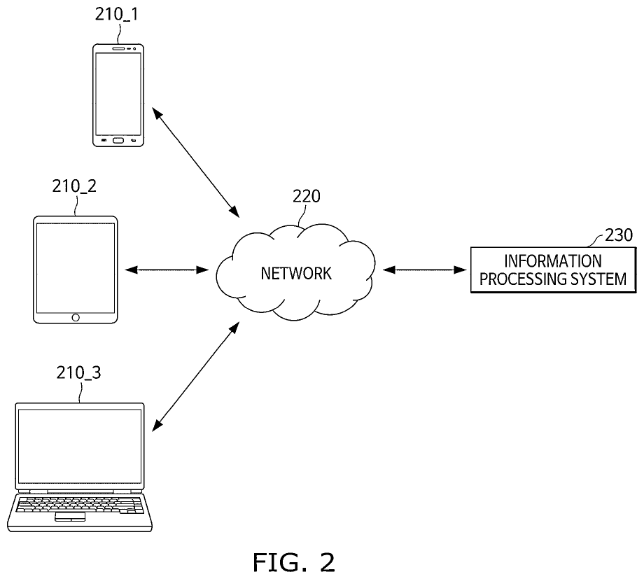

FIG. 2 is a schematic diagram illustrating a configuration in which an information processing system 230 is communicatively connected to a plurality of user terminals 210_1, 210_2, and 210_3 to provide an avatar usage right management service according to an example embodiment. The information processing system 230 may include a system(s) capable of providing an instant messaging service including an avatar provision service, a service for managing avatar usage rights, and the like through a network 220. In this example, the plurality of user terminals 210_1, 210_2, and 210_3 may include a first user terminal, a second user terminal, and the like associated with the instant messaging service. In an example embodiment, the information processing system 230 may include one or more server devices and/or databases, or one or more distributed computing devices and/or distributed databases based on cloud computing services, which are capable of storing, providing and executing computer executable programs (e.g., downloadable applications) and data related to the instant messaging service and the management of avatar usage rights. For example, the information processing system 230 may include separate systems (e.g., servers) for providing the avatar usage rights management service and/or the instant messaging service.

The instant messaging service provided by the information processing system 230 may be provided to the user through the instant messaging application (instant messaging service application) or the like installed in each of the plurality of user terminals 210_1, 210_2, and 210_3. For example, the instant messaging service may include a text messaging service, a voice messaging service, a video call service, a voice call service, a video streaming service, and/or an avatar provision service (e.g., an image creation service, a profile editing service, or story editing service) of a user of the instant messaging application.

The plurality of user terminals 210_1, 210_2, and 210_3 may communicate with the information processing system 230 through the network 220. The network 220 may be configured to enable communication between the plurality of user terminals 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, and so on) that may be included in the network 220 as well as short-range wireless communication between the user terminals 210_1, 210_2 and 210_3.

In FIG. 2, a mobile phone terminal 210_1, a tablet terminal 210_2, and a PC terminal 210_3 are illustrated as the examples of the user terminals, but example embodiments are not limited thereto, and the user terminals 210_1, 210_2 and 210_3 may be any computing device that is capable of wired and/or wireless communication and that can be installed with the instant messaging application and so on and execute the same. For example, the user terminal may include a smartphone, a mobile phone, a navigation system, a computer, a notebook computer, a digital broadcasting terminal, Personal Digital Assistants (PDA), a Portable Multimedia Player (PMP), a tablet PC, a game console, a wearable device, an internet of things (IoT) device, a virtual reality (VR) device, an augmented reality (AR) device, and the like. Further, FIG. 2 illustrates that three user terminals 210_1, 210_2, and 210_3 are in communication with the information processing system 230 through the network 220, but example embodiments are not limited thereto, and a different number of user terminals may be configured to be in communication with the information processing system 230 through the network 220.

In an example embodiment, the information processing system 230 may receive, through an instant messaging application, a request to use an avatar of a second user from a first user terminal associated with the first user. In this case, the first user and the second user may be users registered as messenger friends on the instant messaging service. Then, the information processing system 230 may transmit, through an instant messaging application, the request to use the avatar of the second user to a second user terminal associated with the second user, and receive an acceptance message allowing the use of the avatar of the second user in the first user terminal from the second user terminal through the instant messaging application. In this case, in response to receiving the acceptance message from the second user terminal, the information processing system 230 may register the second user as an avatar friend of the first user. As described above, when the second user is registered as the avatar friend of the first user, it does not mean that the first user is also registered as an avatar friend of the second user.

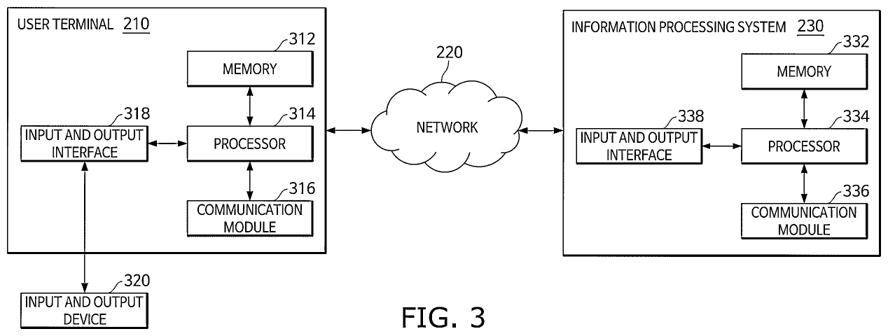

FIG. 3 is a block diagram illustrating an internal configuration of the user terminal 210 and the information processing system 230 according to an embodiment. The user terminal 210 may refer to any computing device that is capable of executing the instant messaging application and so on and also capable of wired/wireless communication, and may include the mobile phone terminal 210_1, the tablet terminal 210_2, and the PC terminal 210_3 of FIG. 2, for example. In an embodiment, the user terminal 210 may refer to a user terminal associated with the first user and/or a user terminal associated with the second user of the instant messaging service.

As illustrated, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information and/or data through the network 220 using the respective communication modules 316 and 336. Further, an input and output device 320 may be configured to input information and/or data to the user terminal 210 or to output information and/or data generated from the user terminal 210 through the input and output interface 318.

The memories 312 and 332 may include any non-transitory computer-readable recording medium. According to an example embodiment, the memories 312 and 332 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 210 or the information processing system 230 as a separate permanent storage device that is distinct from the memory. Further, an operating system and one or more program codes (e.g., a code for the instant messaging application installed and driven in the user terminal 210) may be stored in the memories 312, 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, and so on, for example. As another example, the software components may be loaded into the memories 312 and 332 through the communication modules 316 and 336 rather than the computer-readable recording medium. For example, one or more programs may be loaded into the memories 312 and 332 based on a computer program (e.g., an application that provides instant messaging service, an avatar provision service, or a service for managing avatar usage rights) that is installed by the files provided by the developers or a file distribution system for distributing an installation file of the application through the network 220.

The processors 314 and 334 may be configured to process the instructions of the computer program by performing basic arithmetic, logic, and/or input and output operations. The instructions may be provided to the processors 314 and 334 from the memories 312 and 332 or the communication modules 316 and 336. For example, the processors 314 and 334 may be configured to execute the received instructions according to program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system). For example, a request or data (e.g., a request to use the avatar of the second user) generated by the processor 314 of the user terminal 210 according to the program code stored in the recording device such as the memory 312 or the like may be transmitted to the information processing system 230 through the network 220 under the control of the communication module 316. Conversely, a control signal or instructions provided under the control of the processor 334 of the information processing system 230 may be received by the user terminal 210 via the communication module 336 and the network 220 and through the communication module 316 of the user terminal 210. For example, the user terminal 210 may receive data about the avatar of the second user from the information processing system 230. In FIG. 3, while the communication modules 316 and 336 are illustrated as the components configured separately from the processors 314 and 334, example embodiments are not limited thereto, and the communication modules 316 and 336 may be configured to be included in the processors 314 and 334.

The input and output interface 318 may be a means for interfacing with the input and output device 320. As an example, the input device may include a device such as a camera including an audio sensor and/or an image sensor, a keyboard, a microphone, and/or a mouse, and the output device may include a device such as a display, a speaker, a haptic feedback device. As another example, the input and output interface 318 may be a means for interfacing with a device such as a touch screen that integrates a configuration or function for performing inputting and outputting.

While FIG. 3 illustrates that the input and output device 320 is not included in the user terminal 210, example embodiments are not limited thereto, and the input and output device 320 may be configured as one device with the user terminal 210. Further, the input and output interface 338 of the information processing system 230 may be a means for interfacing with a device (not shown) for inputting or outputting that may be connected to, or included in the information processing system 230. In FIG. 3, while the input and output interfaces 318 and 338 are illustrated as the components configured separately from the processors 314 and 334, example embodiments are not limited thereto, and the input and output interfaces 318 and 338 may be configured to be included in the processors 314 and 334.

The user terminal 210 and the information processing system 230 may include more components than the components illustrated in FIG. 3. Meanwhile, most of the related components may not necessarily require exact illustration. According to an example embodiment, the user terminal 210 may be implemented to include at least a part of the input and output device 320 described above. Further, the user terminal 210 may further include other components such as a transceiver, a Global Positioning System (GPS) module, a camera, various sensors, and/or a database. For example, when the user terminal 210 is a smartphone, it may generally include components included in the smartphone, and for example, it may be implemented such that various components such as an acceleration sensor, a gyro sensor, a microphone module, a camera module, various physical buttons, buttons using a touch panel, input and output ports, and/or a vibrator for vibration are further included in the user terminal 210.

In an example embodiment, the processor 314 of the user terminal 210 may be configured to operate instant messaging application, avatar providing service application, or web browser application, which provides a service for managing avatar usage rights. In this case, the program code associated with the corresponding application may be loaded into the memory 312 of the user terminal 210. While the application is running, the processor 314 of the user terminal 210 may receive information and/or data provided from the input and output device 320 through the input and output interface 318 or receive the information and/or data from the information processing system 230 through the communication module 316, and process the received information and/or data and store it in the memory 312. Further, such information and/or data may be provided to the information processing system 230 through the communication module 316.

While the instant messaging application is running, the processor 314 may receive voice data, text, image, video, and the like input or selected through the input device such a touch screen, a keyboard, a camera including an audio sensor and/or an image sensor, or a microphone connected to the input and output interface 318, and store the received voice data, text, image, and/or video or the like in the memory 312, or provide it to the information processing system 230 through the communication module 316 and the network 220. In an example embodiment, when receiving a user input associated with the request to use the avatar of the second user from the first user through the input device, the processor 314 may provide the corresponding data/request to the information processing system 230 through the network 220 and the communication module 316.

The processor 334 of the information processing system 230 may be configured to manage, process, and/or store the information and/or data received from a plurality of user terminals and/or a plurality of external systems. In an example embodiment, when receiving through the instant messaging application an acceptance message allowing the use of the avatar of the second user, the processor 334 may register the second user as an avatar friend of the first user. When the first user wants to use the avatar of the second user, the processor 334 may transmit data about the avatar of the second user to the user terminal 210 through the instant messaging application.

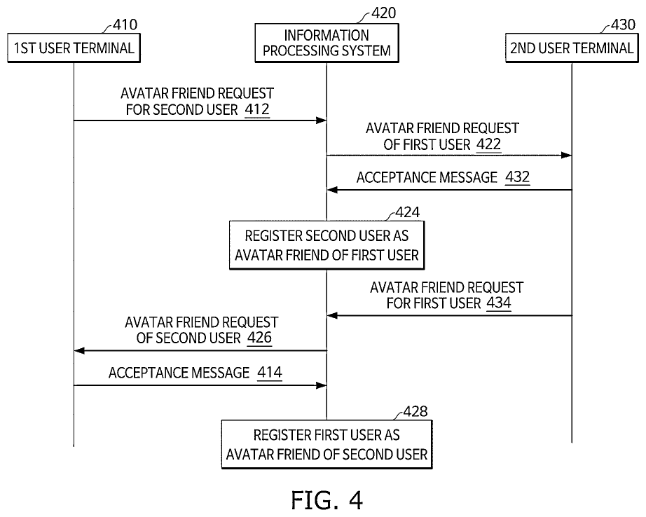

FIG. 4 is a flowchart illustrating a method for performing registration of an avatar friend between a first user terminal 410, an information processing system 420, and a second user terminal 430 according to an example embodiment. In an example embodiment, the first user terminal 410 may be a terminal associated with the first user on the instant messaging application, and the second user terminal 430 may be a terminal associated with the second user on the instant messaging application. In this case, the first user and the second user may be in a messenger friend relationship on the instant messaging service.

As illustrated, the first user terminal 410 may transmit an avatar friend request 412 for the second user to the information processing system 420. For example, the avatar friend request 412 for the second user may be a request to use the avatar of the second user. In an example embodiment, the information processing system 420 may receive the avatar friend request 412 for the second user from the first user terminal 410 through the instant messaging application.

Then, the information processing system 420 may transmit an avatar friend request 422 of the first user to the second user terminal 430 associated with the second user. In an example embodiment, the information processing system 420 may transmit the avatar friend request 422 of the first user to the second user terminal 430 through the instant messaging application. When the second user accepts the avatar friend request 422 of the first user, the information processing system 420 may receive an acceptance message 432 allowing the use of the avatar of the second user in the first user terminal 410 from the second user terminal 430 through the instant messaging application.

In response to receiving the acceptance message 432 from the second user terminal 430, the information processing system 420 may register the second user as an avatar friend of the first user (424). When the second user is registered as the avatar friend of the first user, the first user may be allowed to use the avatar of the second user in the first user terminal 410 associated with the first user. For example, the first user terminal 410 may receive data about the avatar of the second user from the information processing system 420, and generate an image/video including the avatar of the first user and/or the avatar of the second user based on the user input.

As described above, even when the second user is registered as the avatar friend of the first user, this does not mean that the use of the avatar of the first user in the second user terminal 430 is allowed. To use the avatar of the first user, the second user terminal 430 associated with the second user may transmit an avatar friend request 434 for the first user to the information processing system 420. For example, the avatar friend request 434 for the first user may be a request to use the avatar of the first user. In an example embodiment, the information processing system 420 may receive the avatar friend request 434 for the first user from the second user terminal 430 through the instant messaging application.

Then, the information processing system 420 may transmit an avatar friend request 426 of the second user to the first user terminal 410. In an example embodiment, the information processing system 420 may transmit the avatar friend request 426 of the second user to the first user terminal 410 through the instant messaging application. Accordingly, the first user terminal 410 may receive the request to use the avatar of the first user from the second user terminal 430 through the instant messaging application.

In an example embodiment, the first user terminal 410 may receive from the first user a user input accepting the request to use the avatar of the first user (or the avatar friend request 426 of the second user). In this case, the first user terminal 410 may transmit an acceptance message 414 allowing the use of the avatar of the first user in the second user terminal 430 to the information processing system 420. In an example embodiment, the information processing system 420 may receive the acceptance message 414 allowing the use of the avatar of the first user in the second user terminal 430 from the first user terminal 410 through the instant messaging application.

In response to receiving the acceptance message 414 from the first user terminal 410, the information processing system 420 may register the first user as an avatar friend of the second user (428). When the first user is registered as the avatar friend of the second user, the second user may be allowed to use the avatar of the first user in the second user terminal 430 associated with the second user. For example, the second user terminal 430 may receive data about the avatar of the first user from the information processing system 420, and generate an image/video including the avatar of the first user and/or the avatar of the second user based on the user input.

In FIG. 4, it is described that the second user terminal 430 transmits the avatar friend request 434 to the first user after the avatar friend request 422 of the first user is accepted, but example embodiments are not limited thereto. For example, the second user terminal 430 may transmit the avatar friend request 434 for the first user without having received the avatar friend request 422 of the first user or before transmission of the acceptance message 432. In another example, the second user terminal 430 may not transmit the avatar friend request 434 to the first user. In this case, the first user can use the avatar of the second user, but the second user cannot use the avatar of the first user. That is, the second user is registered as the avatar friend of the first user, but the first user is not registered as the avatar friend of the second user.

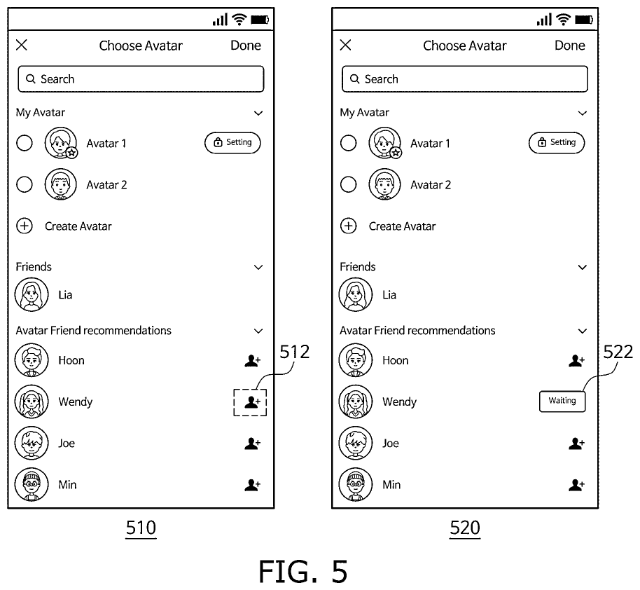

FIG. 5 is a diagram illustrating an example in which a user transmits an avatar friend request according to an example embodiment. In an example embodiment, the user may transmit an avatar friend request to another user (e.g., Wendy) registered as a messenger friend on the instant messaging service. For example, the avatar friend request may be a request to use the avatar of the counterpart. As illustrated, the user may transmit a request to use the avatar of Wendy through a first operation 510 and a second operation 520.

The first operation 510 represents an example of transmitting an avatar friend request through a user interface that includes an avatar friend recommendation list. In the illustrated example, the user interface may include a list of avatars created by the user, the avatar friend list of the user (e.g., Lia), the avatar friend recommendation list, and the like. The avatar friend list may include users registered as the avatar friends of the user, and the user may use the avatars of the avatar friends. In an example embodiment, for the avatar friend, an image including the avatar (e.g., a thumbnail image of the avatar) of the counterpart may be displayed instead of the profile image of the counterpart. Further, for the avatar friend, an icon (e.g., an avatar icon) (not illustrated) indicating that the use of the avatar of the corresponding user is allowed may be displayed on the profile of the counterpart.

The avatar friend recommendation list may include messenger friends of the user who are not registered as the avatar friends of the user. That is, the avatar friend recommendation list may include users whose avatars are not allowed for use among the messenger friends of the user. In an example embodiment, the avatar friend recommendation list may include only the users who have avatars.

As illustrated, the avatar friend recommendation list may include profile images, names, avatar friend request icons, and the like of the user. The user may select an avatar friend request icon 512 with a touch input or the like to transmit an avatar friend request (or a request to use the avatar) to Wendy. In some example embodiments, the user may transmit the avatar friend request to the counterpart through the messenger friend list, the profile screen of the counterpart, or the like.

The second operation 520 represents an example in which the user selects the avatar friend request icon 512 and the avatar friend request icon 512 is changed. For example, when the first user selects the avatar friend request icon 512 with a touch input or the like, the avatar friend request icon 512 may be changed to a waiting icon 522. The waiting icon 522 may be displayed between when the avatar friend request is transmitted to Wendy and when Wendy accepts the request. Before the request to use the avatar of Wendy is accepted by Wendy, the user can only view the avatar thumbnail image of Wendy and cannot use the avatar of Wendy who is registered as a messenger friend.

When the request to use the avatar of Wendy is accepted by Wendy, Wendy may be removed from the avatar friend recommendation list and displayed in the avatar friend list. In an example embodiment, in response to Wendy accepting the avatar friend request, an image including the avatar of Wendy (e.g., avatar thumbnail image of Wendy) may be displayed instead of the profile image of Wendy. Further, an icon indicating that the use of the avatar of Wendy is allowed may be displayed on the profile of Wendy.

When Wendy is registered as an avatar friend of the user, the user can use the avatar of Wendy. For example, the user may receive data on the avatar of Wendy and create an image/video including the avatar of Wendy. In an example embodiment, even when the messenger friend relationship between the user and Wendy is terminated, the user may continue to use the avatar of Wendy. That is, even when the messenger friend relationship between the user and Wendy is terminated, the state in which Wendy is registered as an avatar friend of the user may be maintained.

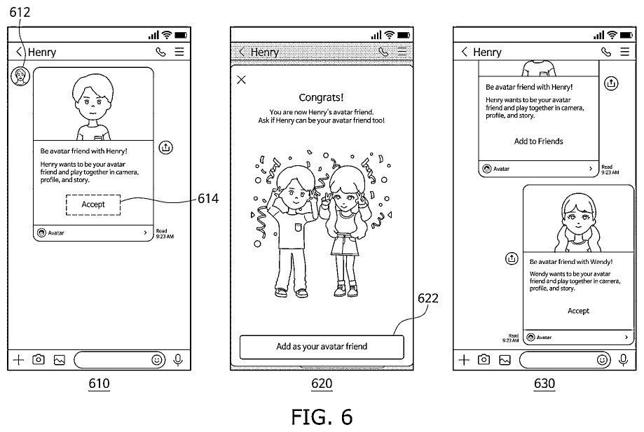

FIG. 6 is a diagram illustrating an example in which the second user accepts the avatar friend request of the first user according to an example embodiment. As described above, when the first user (e.g., Henry) transmits a request to use the avatar of the second user (Wendy), the second user may check and accept the request. In an example embodiment, the second user may check and accept the avatar friend request of the first user through a first operation 610, a second operation 620, and a third operation 630.

The first operation 610 represents an example in which the second user accepts the avatar friend request of the first user. As illustrated, when the first user transmits a request to use the avatar of the second user, a message including the request may be displayed in a chat room that includes the first user and the second user. For example, the message may include a profile image 612 of the first user who transmitted the request, an acceptance button 614 for the request, and the like. The second user may select the acceptance button 614 with a touch input or the like to accept the avatar friend request of the first user. In this case, the second user may be registered as the avatar friend of the first user, and the first user may use the avatar of the second user.

The second operation 620 represents an example of indicating that the second user is registered as an avatar friend of the first user. As described above, when the second user is registered as an avatar friend of the first user, the first user may use the avatar of the second user. On the other hand, when the first user is not previously registered as an avatar friend of the second user, the second user cannot use the avatar of the first user. In this case, the user interface indicating that the second user is registered as an avatar friend of the first user may include an avatar friend request button 622 for the second user to use the avatar of the first user. The second user may select the avatar friend request button 622 with a touch input or the like to transmit a request (or avatar friend request) to use the avatar of the first user to the first user.

The third operation 630 illustrates an example in which the second user selects the avatar friend request button 622 to transmit a request to use the avatar of the first user to the first user. For example, a message including the request may be displayed in the chat room where the first user and the second user are included. Then, when the first user accepts the avatar friend request of the second user, the first user may be registered as an avatar friend of the second user so that the second user can use the avatar of the first user. In an example embodiment, when the first user is registered as an avatar friend of the second user, an image including the avatar of the first user may be displayed instead of the profile image 612 of the first user.

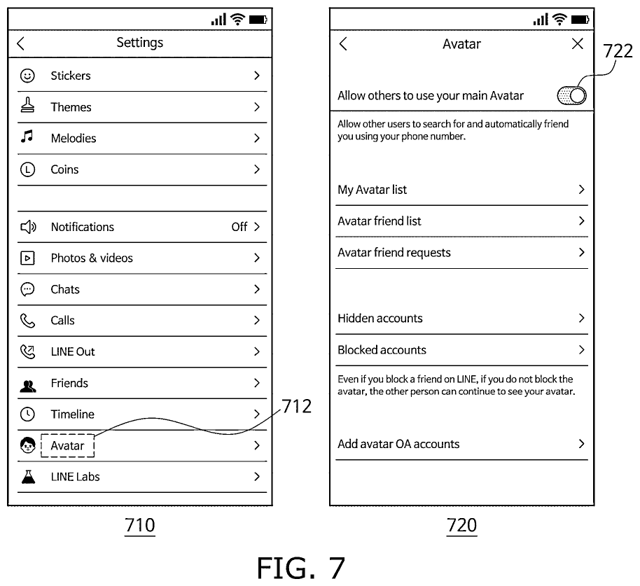

FIG. 7 is a diagram illustrating an example in which the user sets avatar usage rights according to an example embodiment. As illustrated, the user may set the avatar usage rights through the instant messaging application. In an example embodiment, the user may set the usage right for his or her avatar through a first operation 710 and a second operation 720.

The first operation 710 represents an example of a setting screen of the instant messaging application. As illustrated, the setting screen of the instant messaging application includes an avatar setting menu 712 for changing/determining various settings related to the avatar. In addition to the avatar setting menu, the setting screen of the instant messaging application may include menus associated with various services/functions.

The second operation 720 represents that various setting menus related to the avatar are displayed in response to the user selecting the avatar setting menu 712 with a touch input or the like on the setting screen of the instant messaging application. In an example embodiment, the user may select an avatar use allow button 722 with a touch input or the like to allow in advance the other users of the instant messaging application (or all users registered as messenger friends) to use the user's avatar. In this case, the other users may use the avatar of the user without a separate request and/or acceptance.

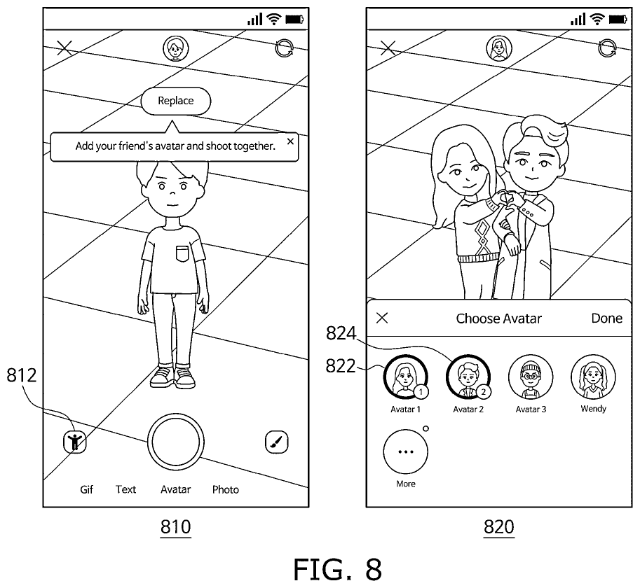

FIG. 8 is a diagram illustrating an example of creating an image including avatars of the other users according to an example embodiment. As illustrated, the user may capture an image or video (e.g., AR video), and the like including the avatars of the other users by using an in-app camera of the instant messaging application, a camera application, or the like. In an example embodiment, the user may capture an image including the avatars of the other users through a first operation 810 and a second operation 820.

The first operation 810 represents an example in which the in-app camera of the instant messaging application is executed so as to capture an image including the avatar of the user. For example, the user may create an AR image/video including his or her avatar (an image/video combining the background of the real world and the user's virtual avatar), and the like. In other words, the processor 314 of the user terminal 210 may control and cause display of an AR image or an AR video including at least one of avatars of the other users in a display area of the user terminal 210, in response to use of the avatars of the other users being allowed in the user terminal 210 associated with the user. In an example embodiment, the user may select an avatar add button 812 with a touch input or the like to add/change the avatar included in the image/video.

The second operation 820 represents an example in which some of the avatars of the other users registered as the avatar friends of the user are selected. In an example embodiment, the user may select the avatar add button 812 to view a list of users (or their avatars) registered as the user's avatar friends. As illustrated, the user may select an avatar 822 of avatar friend 1 and an avatar 824 of avatar friend 2. In this case, the avatar 822 of avatar friend 1 and the avatar 824 of avatar friend 2 may be displayed on the camera screen, and the user may create an image/video including the avatar 822 and the avatar 824. To this end, data about the avatar 822 of avatar friend 1 and the data of the avatar 824 of avatar friend 2 may be received. Here, the data about the avatar may include information on appearance, clothes, possession items, and the like of the avatar, but is not limited thereto.

FIG. 8 illustrates that the user creates an image, a video, and the like using only the avatars of the other users, but example embodiments are not limited thereto. For example, the user may create an image, a video, and the like including his or her avatar and the avatars of the other users. With this configuration, the user may use not only his or her own avatar but also the avatars of the other users who are registered as his or her avatar friends to create images, videos, stickers, emoticons, and the like.

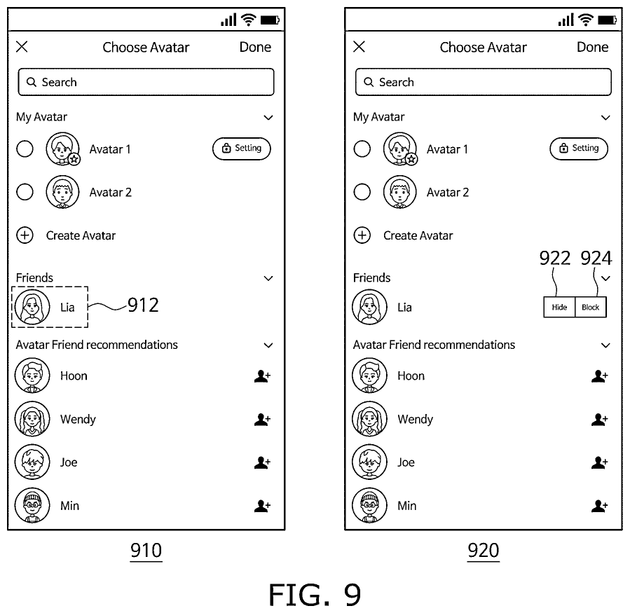

FIG. 9 is a diagram illustrating an example of hiding or blocking an avatar friend according to an example embodiment. As illustrated, the user may hide or block another user (e.g., Lia) who is registered as his or her avatar friend through a first operation 910 and a second operation 920. The first operation 910 represents an example in which the user selects an area 912 corresponding to Lia from among the avatar friends by performing swiping, long pressing, or the like with respect to the area 912.

The second operation 920 represents an example in which a Hide button 922 and a Block button 924 are displayed when the user selects an area 912 corresponding to Lia by performing swiping or long pressing with respect to the area 912. For example, the Hide button 922 and the Block button 924 may be displayed on the right side of the selected other user (Lia). Here, the Hide button 922 may correspond to a button for hiding Lia, who is selected, from the avatar friend list, and the Block button 924 may correspond to a button for blocking Lia from the avatar friend relationship.

In an example embodiment, the user may select the Hide button 922 with a touch input or the like such that Lia is not displayed in the avatar friend list. Further, the user may select the Block button 924 to block Lia from using the user's avatar. In this case, the user also cannot use the avatar of Lia, and Lia may not be displayed in the avatar friend list of the user, and the user may not be displayed in the avatar friend list of Lia.

The Hide button 922 may be displayed only when the counterpart is registered as the avatar friend of the user, and the Block button 924 may be displayed even when the counterpart is not registered as the avatar friend of the user. When a counterpart not registered as the avatar friend is blocked using the Block button 924, the user cannot transmit an avatar friend request to the blocked counterpart, and likewise, the counterpart cannot transmit an avatar friend request to the user.

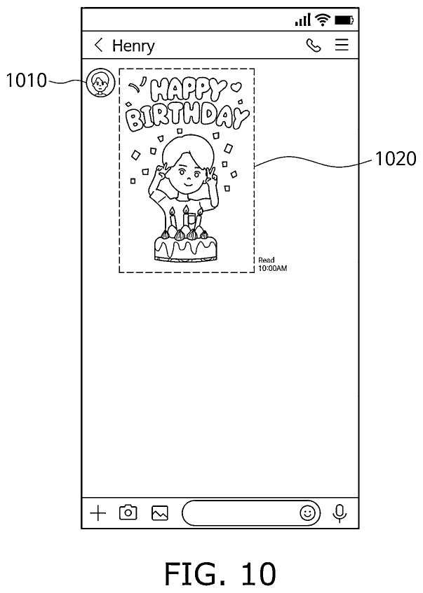

FIG. 10 is a diagram illustrating an example in which an image 1020 for an anniversary is displayed according to an example embodiment. In an example embodiment, an image including an avatar of the second user (Henry) may be displayed in a chat room where the first user and the second user are included. Here, the first user may be a user who is allowed to use the avatar of the second user (that is, the second user is registered as the avatar friend of the first user), and the image may further include at least one of a visual object or a message about an anniversary associated with the first user.

For example, as illustrated, when it is the birthday of the first user, the image 1020 or emoticon including the avatar of the second user (Henry), a message “HAPPY BITRHDAY” to celebrate the birthday, and a visual object such as a cake, confetti, and the like may be displayed in a chat room where the first user and the second user are included. For example, the image 1020 may be displayed in the chat room in the form of an instant message transmitted by the second user. In this case, an image 1010 including the avatar of the second user may be displayed instead of the profile image of the second user who is transmitting the message.

In an example embodiment, the image 1020 may be automatically displayed in the chat room without requiring an input from the user, on an anniversary associated with the first user (e.g., on the birthday of the first user). In some example embodiments, when the first user is registered as the avatar friend of the second user (that is, when the second user can use the avatar of the first user), an image including the avatar of the first user and the avatar of the second user may be displayed in the chat room instead of the image 1020 including only the avatar of the second user (Henry).

In an example embodiment, an image including an avatar allowed for use by at least one or more other users may be displayed in a chat room where three or more users are included. For example, when a third user is registered as the avatar friend of the first, second, and fourth users in a chat room where the first to fourth users are included, an image including the avatar of the third user may be displayed in the chat room. Further, when the second user is not the avatar friend of the third and fourth users in the chat room where the first to fourth users are included, but is registered as the avatar friend of the user (the first user) in association with the anniversary, an image including the avatar of the second user may be displayed in the chat room. In still another example embodiment, with respect to the image associated with the anniversary, an image including an avatar registered in association with a user included in the chat room may be displayed in the chat room regardless of whether or not the user is an avatar friend.

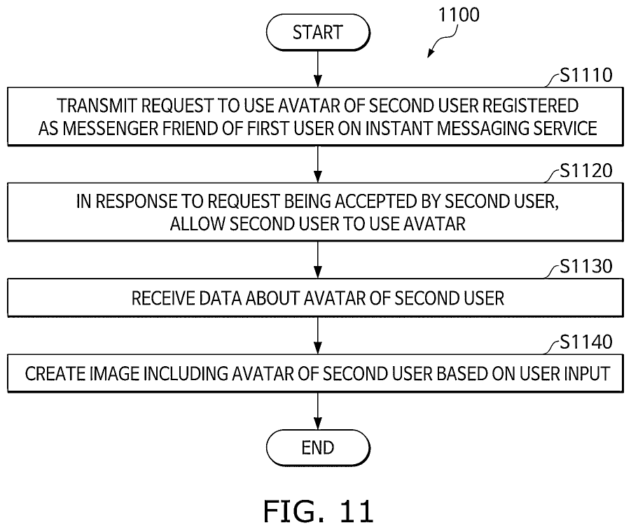

FIG. 11 is a flowchart illustrating a method 1100 for managing avatar usage rights according to an example embodiment. The method 1100 for managing avatar usage rights may be performed by a user terminal (e.g., at least one processor of the user terminal). The method 1100 for managing avatar usage rights may be initiated by the processor transmitting a request to use the avatar of the second user who is registered as the messenger friend of the first user on the instant messaging service, at S1110. The request to use the avatar of the second user may be transmitted to another user terminal associated with the second user through the information processing system.

In response to the request to use the avatar of the second user being accepted by the second user, the processor may allow the avatar of the second user to be used in the user terminal associated with the first user, at S1120. In other words, before the request to use the avatar of the second user is accepted by the second user, the use of the avatar of the second user registered as the messenger friend of the first user may not be allowed. Further, even when the request to use the avatar of the second user is accepted by the second user, the use of the avatar of the first user in another user terminal associated with the second user may not be allowed. In some example embodiments, even when the messenger friend relationship between the first user and the second user is terminated, the use of the avatar of the second user in the user terminal may be maintained as allowed.

In an example embodiment, in response to the request to use the avatar of the second user being accepted by the second user, the processor may display a fourth image including the avatar of the second user instead of the profile image associated with the second user. Further, in response to the request to use the avatar of the second user being accepted by the second user, the processor may display, on the profile of the second user, an icon indicating that the use of the avatar of the second user is allowed.

After the use of the avatar of the second user is allowed, the processor may receive data about the avatar of the second user, at S1130. Further, the processor may generate a first image including the avatar of the second user based on an input of the first user, at S1140. In some example embodiments, the processor may receive data about the avatar of the second user, and generate a second image including the avatar of the first user and the avatar of the second user based on an input of the second. In some example embodiments, the processor may display a third image including the avatar of the second user in the chat room where the first user and the second user are included. In this case, the third image may further include at least one of a visual object or a message for an anniversary associated with the first user.

According to the example embodiments, on an instant messaging service including a first user and a second user, a first terminal of the first user may be set to allow or disallow use of the avatar of the second user with relative ease and flexibility based on prior consent of the second user (e.g., by transmitting a request to use an avatar of a second user by the first user and receiving an acceptance of the request from the second user). Thus, the example embodiments allow or disallow a terminal of the user to use an avatar of another user based on an exchange of communications between the user and another user without engaging substantial computational resources.

The method described above may be provided as a computer program stored in a computer-readable recording medium for execution on a computer. The medium may be a type of medium that continuously stores a program executable by a computer, or temporarily stores the program for execution or download. Further, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. Further, other examples of the medium may include an app store that distributes applications, a site that supplies or distributes various software, and a recording medium or a storage medium managed by a server.

The methods, operations, or techniques of this disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware or combinations of computer hardware and computer software. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

Although the example embodiments described above have been described as utilizing aspects of the currently disclosed subject matter in one or more standalone computer systems, example embodiments are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some example embodiments herein, various modifications and changes can be made without departing from the scope of the present disclosure, which can be understood by those skilled in the art to which the present disclosure pertains. Further, such modifications and changes should be considered within the scope of the claims appended herein.

What is claimed is:

1. A method for managing avatar usage rights performed by a user terminal including at least one processor, the method comprising:
transmitting a request to use an avatar of a second user who is registered as a messenger friend of a first user of the user terminal on an instant messaging service; and
in response to the request to use the avatar of the second user being accepted by the second user, allowing use of the avatar of the second user in the user terminal associated with the first user.

2. The method according to claim 1, further comprising:
receiving data about the avatar of the second user; and
generating an image including the avatar of the second user based on an input of the first user.

3. The method according to claim 1, further comprising:
receiving data about the avatar of the second user; and
creating an image including the avatar of the first user and the avatar of the second user based on an input of the first user.

4. The method according to claim 1, further comprising:
displaying a third image in a chat room, in which the first user and the second user are included, the third image including the avatar of the second user and at least one of a visual object or a message for an anniversary associated with the first user.

5. The method according to claim 1, wherein, before the request to use the avatar of the second user is accepted by the second user, the use of the avatar of the second user registered as the messenger friend of the first user is not allowed.

6. The method according to claim 1, wherein, even when the request to use the avatar of the second user is accepted by the second user, the use of the avatar of the first user in another user terminal associated with the second user is not allowed.

7. The method according to claim 1, wherein, even when a messenger friend relationship between the first user and the second user is terminated, the use of the avatar of the second user in the user terminal is maintained as allowed.

8. The method according to claim 1, further comprising:
in response to the request to use the avatar of the second user being accepted by the second user, displaying a fourth image including the avatar of the second user instead of a profile image associated with the second user.

9. The method according to claim 1, further comprising:
in response to the request to use the avatar of the second user being accepted by the second user, displaying an icon , which indicates that use of the avatar of the second user is allowed, on a profile of the second user.

10. The method according to claim 1, further comprising:
receiving a request to use the avatar of the first user from another user terminal associated with the second user;
receiving an input of the first user accepting the request to use the avatar of the first user; and
in response to receiving the input of the first user, transmitting an acceptance message allowing the use of the avatar of the first user in the another user terminal.

11. The method according to claim 10, further comprising:
before transmitting the acceptance message, disallowing the use of the avatar of the first user in the another user terminal.

12. The method according to claim 1, further comprising:
receiving an input of the first user allowing other users to use the avatar of the first user, and
in response to receiving the input of the first user, allowing the use of the avatar of the first user in another user terminal associated with the second user , from among the other users.

13. A non-transitory computer-readable recording medium storing instructions that, when executed by at least one processor, cause a user terminal to perform the method according to claim 1.

14. A user terminal, comprising:
a memory configured to store one or more computer-readable programs; and
one or more processors connected to the memory and configured to execute the one or more computer-readable programs stored in the memory, such that the one or more processors cause the user terminal to,
transmit a request to use an avatar of a second user who is registered as a messenger friend of a first user on an instant messaging service, and
in response to the request to use the avatar of the second user being accepted by the second user, allow use of the avatar of the second user in the user terminal associated with the first user.

15. An information processing system comprising:
a memory configured to store one or more computer-readable programs; and
one or more processors connected to the memory and configured to execute the one or more computer-readable programs included in the memory such that the one or more processors are configured to cause the information processing system to,
receive a request to use an avatar of a second user from a first user terminal associated with a first user through an instant messaging application, the first user and the second user being users registered as messenger friends on an instant messaging service,
transmit the request to use the avatar of the second user to a second user terminal associated with the second user through the instant messaging application,
receive an acceptance message allowing use of the avatar of the second user in the first user terminal from the second user terminal through the instant messaging application, and
in response to receiving the acceptance message from the second user terminal, register the second user as an avatar friend of the first user.

16. The information processing system according to claim 15, wherein the one or more processors are further configured to cause the information processing system to transmit data about the avatar of the second user to the first user terminal through the instant messaging application in response to registering the second user as an avatar friend of the first user.

17. The information processing system according to claim 15, wherein the one or more processors are further configured to cause the information processing system to transmit an image to the first user terminal through a chat room, in which the first user and the second user are included, the image including the avatar of the second user and at least one of a visual object or a message for an anniversary associated with the first user.

18. The information processing system according to claim 15, wherein the one or more processors are further configured to cause the information processing system to disallow the use of the avatar of the second user, before the second user is registered as the avatar friend of the first user.

19. The information processing system according to claim 15, wherein the one or more processors are further configured to cause the information processing system to disallow the use of the avatar of the first user in the second user terminal, even when the second user is registered as the avatar friend of the first user.

20. The information processing system according to claim 15, wherein the one or more processors are further configured to cause the information processing system to,
receive a request to use an avatar of the first user from the second user terminal through the instant messaging application;
transmit the request to use the avatar of the first user to the first user terminal through the instant messaging application;
receive an acceptance message allowing use of the avatar of the first user in the second user terminal from the first user terminal through the instant messaging application;
in response to receiving the acceptance message from the first user terminal, register the first user as an avatar friend of the second user; and
in response to registering the first user as the avatar friend of the second user, transmit data about the avatar of the first user to the second user terminal through the instant messaging application.
